(19) United States
(12) Patent Application Publication
(10) Pub. No.: US 2007/0149376 A1
(43) Pub. Date: Jun. 28, 2007

(54) VACUUM COOLING ROLLER

(76) Inventor: Bruno Holtmann, DIELSDORF (CH)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/538,604

(22) PCT Filed: Oct. 21, 2003
(86) PCT No.: PCT/EP03/11613

§ 371 Date: Jan. 4, 2007

(30) Foreign Application Priority Data
Dec. 10, 2002 (DE) 102 57 496.0

(51) Int. Cl. F16C 13/00

(52) U.S. Cl. 492/16; 165/89

(57) ABSTRACT

The invention relates to a vacuum cooling roller for steel-like materials, particularly for paper webs or cardboard webs, plastic or metal foils. whose sleeve has air passage openings (22), which can be subjected to a vacuum at least in the wrapping area of the web and which have means for cooling the jacket surface (9). The cooling of the jacket surface (9) ensues via cooling channels (21), particularly bores, which axially run inside the roller sleeve (9) and through which a cooling medium flows.

### FIELD OF THE INVENTION

The invention relates to a suction cooling roller for a strip-shaped web, in particular for a paper or cardboard web or plastic or metal foil, whose surface is formed with holes and where suction is applied at least to a contact region with the web and that has means for cooling the roller surface.

### STATE OF THE ART

A roller for cooling or heating a web is known from German 198 14 597. The roller described there has a roller jacket with a heat exchanger provided inside the roller jacket and connected with a supply device for feeding in and drawing out an external primary heat-exchanger fluid. The secondary side of the heat exchanger holds the internal heat-exchange fluid that is sprayed from a coaxially mounted heat exchanger against the inner surface of the jacket, the flow path including a pump in the roller. From the inner roller jacket the heat-exchange fluid is moved by the pump back into the heat exchanger in the center of the roller where the heat picked up is given off to the primary loop.

The roller is thus cooled at its inner jacket face so that the outer surface of the roller is only indirectly cooled.

German 198 47 799 describes a suction roller that has a suction system and holes in the roller surface that make it possible to suck air in between the roller and the web. With high web travel speeds the boundary air layer adhering to the web creates problems as the web comes into contact with the roller.

Air gets trapped between the web and the roller causing the web to float and reducing the contact. Reduction of the contact area reduces the amount of tension that can be exerted. The described suction roller has a rotatably driven jacket mounted on a stationary inner part that has air intakes over its entire surface communicating with a suction chamber at subatmospheric pressure in the contact region. The subatmospheric pressure thus is effective through the center tube and the bores through the jacket of the center tube inside the roller in the suction chamber and thence via the air intakes. There is no system for cooling the roller surface in this reference.

A combined cooled suction roller is known from German 4,118,039. In an outer surface of the roller that is traversed by the coolant there are grooves between which are ridges that support a perforated outer skin. The grooves are connected with grooves in a stationary part that is connected to a suction shaft so that suction is applied to the web while the coolant cools the web through the skin.

The coolant is fed in via a hollow shaft and conducted via supply lines into an intermediate chamber between an inner and outer drum surface. The intermediate chamber is subdivided by ribs that extend diagonally over the periphery of the drum. At the other end of the roller the coolant is also drawn out of the roller via conduits and a hollow shaft. The heat exchange with the coolant takes place via a skin carried on the roller on the outer roller surface. The heat exchange is made less efficient by many boundary layers and the suction in the grooves of the outer drum surface. A further disadvantage is the complex construction of the system for feeding the coolant through the roller.

### OBJECT OF THE INVENTION

Starting from this state of the art, it is an object of the invention to improve a suction cooling roller so that with minimal extra cost better cooling of the roller surface is achieved and the maximum and most uniform possible suction is produced on the roller surface.

This object is achieved in that the surface of the jacket is cooled by axially extending passages, e.g. bores, formed in the jacket and traversed by a coolant. By putting the cooling passages directly in the wall of the jacket, it is possible to cool the surface of the jacket directly, without having to worry about a boundary layer interfering with heat exchange. In particular the use according to the invention of aluminum for the roller jacket and its high heat conductivity makes it possible to efficiently cool the web workpiece.

### BRIEF DESCRIPTION OF THE DRAWING

A preferred embodiment of the of the suction cooling roller is shown in the drawing and more closely described in the following.

Therein

FIG. 1 is a section through a suction cooling roller mounted in a machine frame.

### EMBODIMENTS OF THE INVENTION

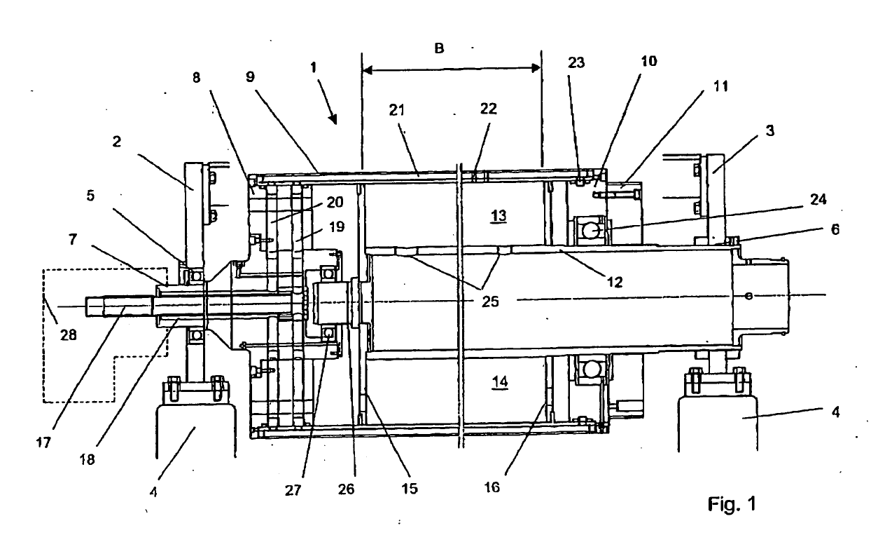

FIG. 1 shows a suction cooling roller 1 carried on two supports 2 and 3 of a base 4. The support 2 holds a bearing 5 and the support 3 has a bore 6. The roller 1 has a stub shaft 7, an end flange 8, a roller jacket 9, another end flange 10, a pulley 11 mounted thereon, a tubular inner part 12, partitions 13 and 14 extending axially along and projecting radially from the part 12, and transverse partitions 15 and 16 projecting radially from and spaced along the axis.

The stub shaft 7 is formed with concentric feed passages 17 and 18 that serve as intake 17 and outlet 18 for a coolant. The feed passages 17 and 18 are connected with bores in the end flange 8. The end flange 8 has respective bores 19 and 20 that are connected with cooling passages 21 in the roller jacket 9. The roller jacket 9 is made of a metal having a thermal conductivity of at least 100 W/(m K), preferably aluminum. Steel is used under circumstances when for example the considerable length of the roller precludes the use of aluminum alloys for reasons of strength. In order to increase friction and resistance to wear, the surface of the jacket 9 is hardened. Preferably the hardening is achieved by anodic or plasma-coating with a ceramic. The cooling passages 21 are formed by axially extending bores running the full roller length in the roller jacket 9 and the angular spacing between the passages is 10 mm to 100 mm and they are uniformly angularly distributed. The diameter of the bores is determined by the thickness of the jacket and is between about 8 mm and 30 mm.

In order to obtain the most uniform temperature profile 10 over the length of the roller jacket 9, in a preferred embodiment the coolant runs oppositely in adjacent passages 21. Thus the coolant flows axially out in one passage 21 and back in the adjacent passage 21. Outgoing coolant passages 21 thus alternate in the jacket 9 with incoming coolant passages 21. This has a 15 considerable influence on the temperature distribution in the jacket 9. If the jacket 9 is only traversed in one direction, its coolant-input end will get hotter than its outlet end. The result is a considerable temperature differential between the jacket ends.

With alternating flow through the jacket 9 there is a more uniform temperature profile in the roller jacket 9.

The connection between an outgoing passage 21 and a return passage 21 is effected by bridge passages 23 in the end flange 10 that connect two adjacent cooling passages or via an annular passage 23 that interconnects all the cooling passages at the end flange.

In a further embodiment of the invention the coolant is fed to the jacket 9 into and out of both of the end flanges 8 and 10. Here the alternation of flow directions in adjacent passages is maintained so that there is a minimal temperature differential between the roller ends.

Between the axially extending bores forming the cooling passages 21 in the roller jacket 9 there are radially extending holes 22. The holes 22 serve as air intakes for production of suction at the outer face of the roller. Preferably the holes 22 are of the same diameter and are uniformly distributed over the jacket 9. Thus for example a parallelogrammatic array on the roller surface is obtained with holes 22 spaced axially by 20 mm and angularly by 30 mm. Here the number of holes 22 according to the required suction at the roller surface can vary from 1 hole per 100 cm² to 100 holes per 100 cm². For thin workpiece webs a hole diameter of 1 mm to 3 mm is used. The holes 22 can be connected via shallow grooves on the roller jacket 9. The shallow grooves have a depth of about 2 mm.

The input bore 19 is connected with a cooling passage 21 by which the coolant is circulated in the jacket 9. On the opposite end of the roller jacket 9, the coolant passage 21 is connected via a passage 23 in the end flange 10 with an adjacent coolant passage 21 through which the coolant flows back. At the outlet end the coolant flows through the feed passage 20 and the outlet bore 18 out of the roller 1.

The inner periphery of the flange 10 supports the roller jacket 9 by means of a bearing 24 on the inner part 12. Similarly a drive wheel 11 in the form of a belt pulley is screwed to the face of the end flange 10. Instead of the drive wheel 11 there can 5 be a drive gear or similar drive element.

The axially extending and radially projecting partitions 13 and 14 and the radially extending and axially spaced partitions 15 and 16 are fixed on the inner part 12. These serve to define a region B of the roller so that only the region of the roller jacket that is engaged by the material web is subjected to suction. The angular delimiting is necessary to prevent whistling of uncovered bores subjected to suction. In addition the suction pump does not do unnecessary work. The chamber defined by the partitions 13, 14, 15, and 16 is evacuated via bores 22 in the inner part 12.

It is also possible according to the invention to make the axially spaced partitions 15 and 16 movable in order to vary the length of the suction region B. This is particularly effective when webs of different widths are being handled by the suction cooling roller.

The inner part 12 is mounted fixedly at 6 on the support 3 and at the opposite end is supported by a stub shaft 26 in a bearing 27 in the bearing 7 so that the roller jacket can rotate on the inner part 12. As the roller jacket 9 rotates, only the region B is internally evacuated.

During operation of the suction cooling roller 1 the coolant is supplied by a rotary coupling 28 to the input passage 17 and flows via the feed passages 19 into the cooling passages 21 of the roller jacket. The coolant reduces the temperature of the jacket 9 that is otherwise heated by the workpiece. Heat exchange is optimized by the suction that adheres the web to the jacket 9. 5 The adherence of the web not only ensures excellent heat exchange, but also a safe advance of the web, so that it can be held under considerable tension. The coolant then flows via the bridge passages 23 in the end flange 10 into the other passages 21 and thence back along the jacket 9 to the return feed passage 20 and finally via the rotary coupling 28 out of the system. As the jacket 9 is cooled, suction is applied to the chamber 24, being created by a pump connected to the inner part 12. The combination of a cooled roller jacket and suction system together make it possible to get optimal cooling and a large and uniformly distributed suction effect on the roller surface.

1-15. (canceled)

16. A roller assembly for advancing and cooling a flexible web, the assembly comprising:
a support;
a roller rotatable on the support about an axis and having
a generally cylindrical jacket centered on the axis and formed with an array of radially throughgoing holes and an array of axially extending passages between the holes, and
axially spaced flanges at respective ends of the jacket, one of the end flanges being formed with at least one bridge passage into the cooling passages open, the other end flange being formed with input and output feed passages connected to the feed passages;
suction means for drawing air from out of an interior inside and between the flanges of the jacket and thereby sucking air in through the holes, whereby the air being sucked in through the holes adheres the web to the jacket;
cooling means for feeding a coolant to the input passage and withdrawing it from the output passage of the other end flange and thereby circulating the coolant in two axially opposite directions through the cooling passages.

17. The roller-assembly defined in claim 16 wherein the bridge passage is an annularly continuous passage into which all of the cooling passages open at the respective end of the jacket.

18. The roller assembly defined in claim 18 wherein the jacket is generally cylindrical.

19. The roller assembly defined in claim 16 wherein the jacket has a thermal conductivity of at least 100 W/(m K).

20. The roller assembly defined in claim 16 wherein the jacket is of aluminum.

21. The roller assembly defined in claim 16 wherein the cooling passages are spaced angularly by between 10 mm and 100 mm and the cooling passages are between 8 mm and 30 mm in diameter.

22. The roller assembly defined in claim 16 wherein the jacket has an outer diameter between 200 mm and 1200 mm.

23. The roller assembly defined in claim 16 wherein there are between 1 and 100 holes per 100 cm² of outer surface area of the jacket.

24. The roller assembly defined in claim 16 wherein the roller surface is formed with shallow grooves into which the holes open.

25. The roller assembly defined in claim 16 wherein the roller further has
a tube coaxially inside the jacket and fixed in the support,
axially extending and angularly spaced partitions extending radially from the tube to an inner surface of the jacket, and
axially spaced partitions extending generally perpendicular to the axis from the tube between the axially extending partitions and defining therewith inside the jacket a compartment in which an angularly and.
axially limited region of the inner jacket surface is exposed,
the suction means opening only through the tube into the compartment, whereby air is only drawn through the holes over the limited region of the jacket.

26. The roller assembly defined-in claim 25, further comprising
a bearing supporting one of the end plates on the tube; and
bearings supporting the other of the end plates on the tube and on the support.

27. The roller assembly defined in claim 26, further comprising
drive means including a drive wheel connected to one of the end plates for rotating the roller about the axis.

28. The roller assembly defined in claim 25 wherein at least one of the axially spaced partitions is axially shiftable.
